(19) United States
(12) Patent Application Publication
(10) Pub. No.: US 2022/0383100 A1
(43) Pub. Date: Dec. 1, 2022

(54) COST-EFFICIENT REINFORCEMENT LEARNING USING Q-LEARNING

(71) Applicant: International Business Machines Corporation, Armonk, NY (US)

(72) Inventors: Yada Zhu, Irvington, NY (US); Miao Liu, Ossining, NY (US); Alexander Gray, Yonkers, NY (US); Nitin Gaur, Round Rock, TX (US); Prasenjit Dey, Kolkata (IN)

(21) Appl. No.: 17/335,601

(22) Filed: Jun. 1, 2021

(51) Int. Cl. G06N 3/08; G06N 3/04; G06F 30/27; G06Q 40/04

(52) U.S. Cl. CPC G06N 3/08; G06N 3/0454; G06F 30/27; G06Q 40/04

(57) ABSTRACT

A first neural network can be trained to approximate a state-action value function to estimate an expected cumulative return for an agent to perform an action in a given state, the agent being an autonomous reinforcement learning agent running on the processor. A second neural network can be trained to generate a simulated experience, the second network trained to predict a simulated state at a next time step after performing a given action, the second neural network being trained using real experience in a real environment. The first neural network is trained based on the simulated experience and a real experience from a real environment. A selected action selected by the second neural network given a current state of the real environment can be performed. The agent can explore an action space by uniformly sampling an action from all possible remaining action-state space combinations and performing the sampled action.

### BACKGROUND

The present application relates generally to computers and computer applications, and more particularly to machine learning and reinforcement learning.

Reinforcement learning (RL) technique enables an agent to learn in an interactive environment by trial and error using feedback from its own actions and experiences. Empirical application of RL to optimal trade execution problems uses Q-learning which is based on tabular representations and linear function approximations to explain the relationship between market state variables and optimal actions, which might have limited representation power for high dimensional financial data. Trade execution refers to completion of buy and sell order for security, and is referred to as order completion herein. Existing works have applied more advanced RL techniques, such as Deep Q-networks (DQN), double DQN, and proximal policy optimization (PPO) to financial trading problems. While they have shown better performance than standard approaches, the works are developed under the static market assumption, where the market environments are represented by historical limit order books that do not change after trade execution and generally do not take into account the market impact. Because an average-sized order can have a non-negligible impact and change the market immediately, the performance of RL agents trained with static historical data could degrade dramatically when they are applied to dynamic markets. Existing works are also based on direct RL approaches (also called model-free RL), which directly learn a policy from samples collected from agent-environment interactions. While direct RL approaches are usually simple, they may be sample inefficient and may require a large number of agent-market interactions to learn a good policy, which can lead to a training overhead when they are applied to real markets.

### BRIEF SUMMARY

The summary of the disclosure is given to aid understanding of a computer system and method of cost-efficient Q-learning, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A system and method for reinforcement machine learning can be provided. In an aspect, the system can include a processor and a memory device coupled with the processor. The processor can be configured to train a first neural network to approximate a state-action value function to estimate an expected cumulative return for an agent to perform an action in a given state. The agent can be an autonomous reinforcement learning agent running on the processor. The processor can also be configured to train a second neural network to generate a simulated experience, the second network trained to predict a simulated state at a next time step after performing a given action, the second neural network being trained using real experience in a real environment. The processor can also be configured to train the first neural network based on the simulated experience and based on a real experience from a real environment. The agent can be configured to perform a selected action selected by the first neural network given a current state of the real environment. In an aspect, the agent can also be configured to uniformly explore an action space by uniformly sampling an action from all possible remaining action-state space combinations and performing the sampled action.

A computer-implemented method, in an aspect, can include training a first neural network to approximate a state-action value function to estimate an expected cumulative return for an agent to perform an action in a given state. The agent can be an autonomous reinforcement learning agent running on the processor. The method can also include training a second neural network to generate a simulated experience, the second network trained to predict a simulated state at a next time step after performing a given action, the second neural network being trained using real experience in a real environment. The first neural network can be trained based on the simulated experience and a real experience from a real environment. The method can also include performing a selected action selected by the first neural network given a current state of the real environment. In an aspect, the method can also include, for example, the agent, uniformly exploring an action space by uniformly sampling an action from all possible remaining action-state space combinations and performing the sampled action.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIGS. 1A-1D illustrate components of a tool incorporating cost-efficient deep Q-learning for trade execution in an embodiment.

FIG. 2 shows a snapshot of a limit order book in an embodiment.

FIG. 3 is a flow diagram illustrating a method in an embodiment for cost-efficient deep Q-learning in an embodiment.

FIG. 4 is a diagram showing components of a system in one embodiment that can provide a reinforcement learning (RL) framework for order completion on dynamic market.

FIG. 5 illustrates a schematic of an example computer or processing system that may implement a system in one embodiment.

FIG. 6 illustrates a cloud computing environment in one embodiment.

FIG. 7 illustrates a set of functional abstraction layers provided by cloud computing environment in one embodiment of the present disclosure.

### DETAILED DESCRIPTION

Systems and methods can be provided that implement a cost-efficient reinforcement learning (RL) approach that integrates deep reinforcement learning and planning to reduce the training overhead while improving the performance, e.g., trading performance, e.g., a cost-efficient hybrid algorithm for optimal trade execution policy learning. In an embodiment, the system and/or method can include a learnable market environment model, which approximates the market impact using real market experience, to enhance policy learning via the learned environment, and a state-balanced exploration scheme to solve the exploration bias caused by the non-increasing residual inventory during the trade execution to accelerate model learning.

Generally, an order can result in changes to supply/demand equilibrium and cause adverse price movement in the dynamic market. This effect is known as market impact. The market impact often causes the actual execution price for large orders to be worse than the initially observed price on the market. This difference in prices can be a source of trading costs. An automated reinforcement learning (RL), which takes into account the market impact, can minimize trading costs for optimal trade execution.

A cost-efficient RL framework is disclosed, which integrates deep reinforcement learning and planning, which can reduce the training cost while saturating model's performance. In an embodiment, the RL framework includes a learnable market environment model, which approximates the market impact using real market experience, to enhance policy learning via the learned environment. A state-balanced exploration scheme solves the exploration bias caused by the non-increasing inventory during the trade execution. By learning from both the learned environment and the real market interactions, the RL framework can increase the sample efficiency and outperform existing methods. In an embodiment, the RL framework employs a hybrid RL approach that combines both direct reinforcement learning and planning, via a learnable market environment model, to increase the sample efficiency. A state-balanced exploration scheme for trade execution tasks, solves the sample bias caused by the simple random exploration in the classical ϵ-greedy method.

Dynamic Market Environment

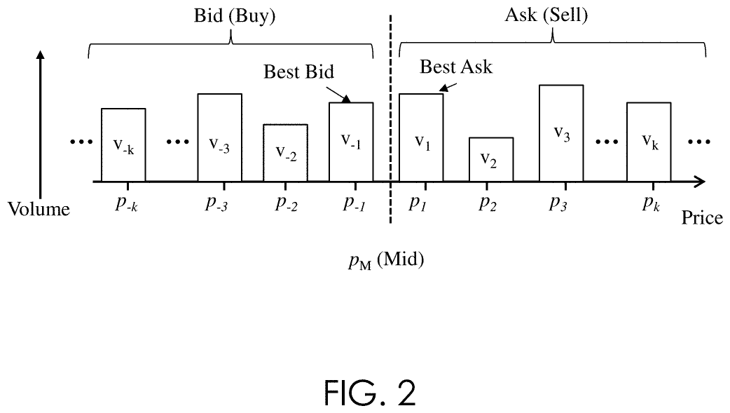

In order-driven exchange markets, market order (MO) and limited order (LO) are two major types of orders. MOs refer to orders requested to buy/sell immediately at the current market price. MOs are subject to large trading slippage (price change) due to execution speed requirements. LOs offer to buy/sell (equivalently, bid/ask) given quantities (volume) of an asset at no more/less than certain price limits. Due to the restricted price, LOs can lead to delayed fulfillment or an increased chance of unfulfillment. A collection of LOs at different price levels awaiting to be executed by counterpart MOs is called a limit order book (LOB). LOB provides information about the market status. FIG. 2 shows a snapshot of a LOB, where pₖ∈ [symbol] ⁺ and vₖ∈ [symbol] ⁺ denote price and volume of LOs at level k, k∈ [symbol] ⁻ and k∈ [symbol] ⁺ correspond to buy and sell, and p_{M} is the mid-price, also referred as reference-price, given by arithmetic mean of the best ask price and best bid price. In this snapshot of a LOB, the x-axis and y-axis correspond to the limit order price and volume (quantity), respectively. The bars are associated with buy or sell LOs with different bid or ask prices and the bar height is the total volume of all the LOs at the corresponding price level.

Limit orders at each price level of a LOB form a queue. At any time, three types of events including new MOs, new LOs, and cancellation of LOs can arrive and change the price levels in a LOB and the queue length at each price level. The system and/or method in an embodiment can introduce a queue-reactive-based virtual market to represent the real-world market environment. In a specific example, the intensity function of each event types for each combination of level k and queue size v=(v_{-K}, . . . , v₋₁, v₁, . . . , v_{K})∈ [symbol] ^{2K} is estimated based on queue-reactive model using historical LOBs over a time horizon. The queue size is approximated by the smallest integer that is larger than or equal to the volume available at the queue divided by the stock's average order size (denoted as AOSₖ) at the corresponding level k. With this approximation, the virtual market models market dynamics as a continuous-time Markov jumping process in 2K countable state space, where the queue length increasing rate (decreasing rate) is given by the intensity of new LOs (total intensity of new MOs and cancellation of LOs). Mid-price p_{M} changes if a MO or cancellation of a LO results in queue size at the best ask or best bid depletes to zero, i.e., v₁=0 or v₋₁=0; and the price at each level k shifts if new LOs are inserted in the LOB. Putting everything together, the virtual market explicitly considers the sophisticated market impact induced by executing the large orders from financial institutions as well as the probabilistic events of new market orders, new limit orders, and cancellation of limit orders. In this way, the virtual market provides a more realistic dynamic market environment than that represented by static LOBs.

Reinforcement Learning for Order Completion

The large order execution problem requires an agent to liquidate large numbers of equity shares, e.g., I unites, by the end of time period t=T while maximizing its trading profit. Let sₜ, aₜ denote the state and the action of the RL agent at time t, and r(sₜ, aₜ) be the corresponding trading profit. An optimal trade execution policy maximizes the expected return from selling all the shares

arg maxₐ_{₀}_{,a}_{₁}_{, . . . ,a}_{_{T}} [symbol] [Σₜ₌₀^{T}r(sₜ,aₜ)]

subject to trading cost due to market impact.

State space ( [symbol] ): Each state s∈ [symbol] is a vector of state attributes. The state space [symbol] = [symbol] _{agent}∪ [symbol] ₘₐᵣₖₑₜ includes two subspaces: (i) the agent-state sₐ∈ [symbol] _{agent} consisting of residual inventory (rest_I), residue time (rest_T), and decision price p_{D} (the mid-price at t=0); (ii) the market-state sₘ∈ [symbol] ₘₐᵣₖₑₜ consisting of queue size v of LOB, current mid-price p_{M}, signed volume and volatility.

Action space ( [symbol] ): [symbol] ={a|a∈[0, 1, 2, . . . , rest_I]}, i.e., selling a units of shares as a market order. The action space includes market orders.

Reward function: The reward function captures the immediate reward after an order has been executed, i.e.,

R(s,a)=(r(s,a)−p_{D}·a)/p_{D}. (1)

Eq. (1) evaluates the relative trading cost compared to selling a units of shares at the decision price p_{D}. p_{D} is given by pₘ at the beginning of the trading period.

In an embodiment, the goal in the RL framework for optimal trade execution is to learn a policy π: [symbol] → [symbol] that maximizes the expected return

Gₜ= [symbol] _{π}[Σₖ₌₀^{T-t}γ^{k}R_{t+K}|sₜ],

where γ∈(0,1] is a discount factor. In an embodiment, considering trade execution problems are often performed in a short period of time, the discount factor is set to be 1. In an embodiment, the system and/or method uses a discrete setting for the trading time horizon. In another embodiment, an event-driven decision-making model with a continuous time horizon can be used. In an embodiment, the system and/or method learns the policy by estimating the action-value function Q_{π}(s, a), given by

Q_{π}(s,a)= [symbol] _{π}[Σₖ₌₀^{T-t}γ^{k}Rₜ₊ₖ|sₜ=s,aₜ=a]. (2)

In an embodiment, the Q-functions can be parameterized via a set of weights θ, i.e., Q_{θ}(s, a)≈Q_{π}(s, a). In an embodiment, neural networks are used as the parameterization approach in RL.

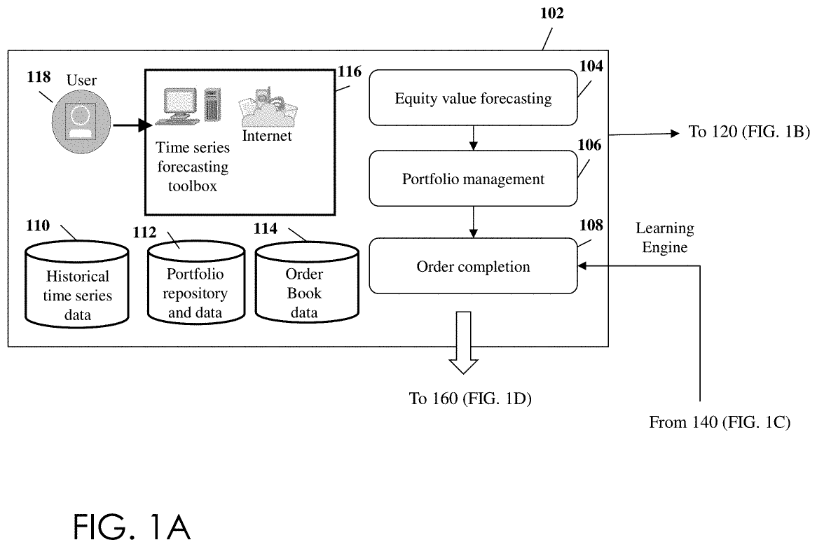

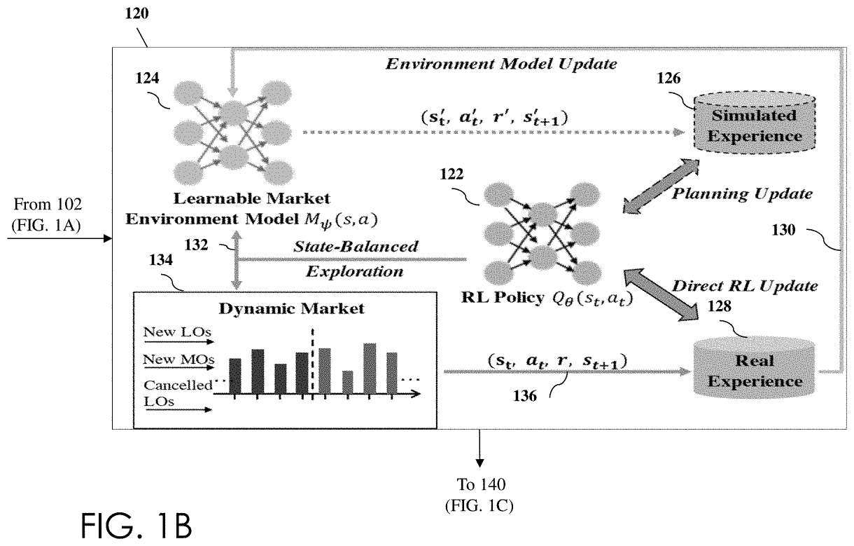

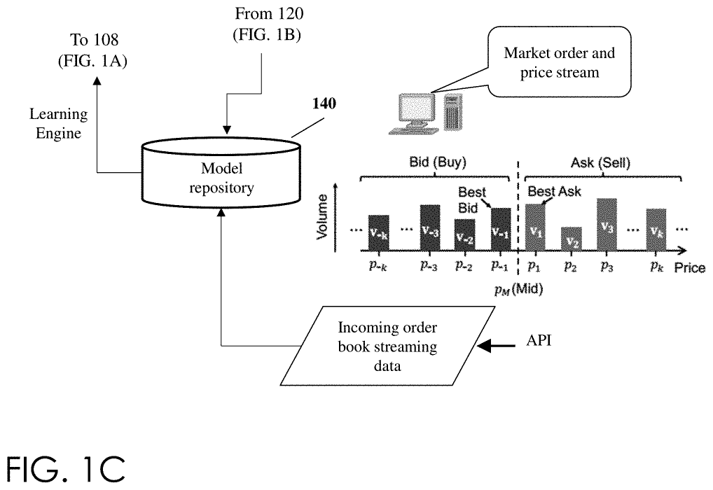

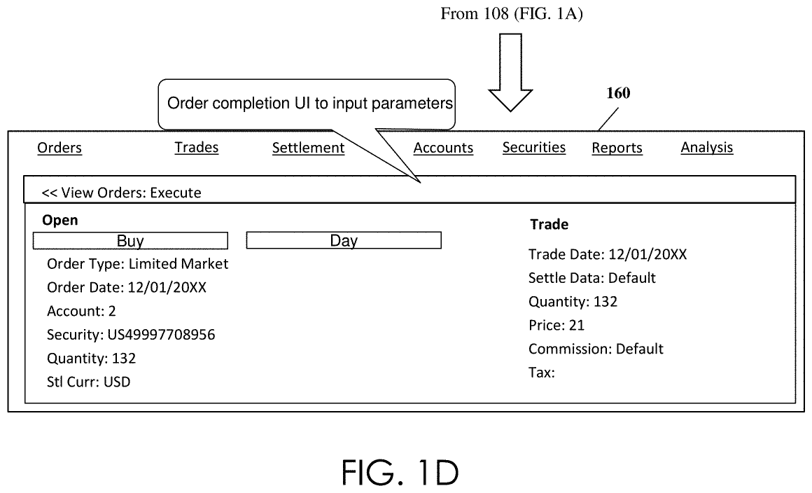

FIGS. 1A-1D illustrate components of a tool incorporating cost-efficient deep Q-learning for trade execution in an embodiment. A decision process involves sequentially executing portions of the large orders based on the latest market status to achieve the maximum profit. An RL agent or a processor can be trained to perform such sequentially actions autonomously.

FIG. 1A shows an interface of the tool in an embodiment via which a user may place an order and monitor completion of the order. The components shown include computer-implemented components, for instance, implemented and/or run on one or more hardware processors, or coupled with one or more hardware processors. One or more hardware processors, for example, may include components such as programmable logic devices, microcontrollers, memory devices, and/or other hardware components, which may be configured to perform respective tasks described in the present disclosure. Coupled memory devices may be configured to selectively store instructions executable by one or more hardware processors.

A processor may be a central processing unit (CPU), a graphics processing unit (GPU), a field programmable gate array (FPGA), an application specific integrated circuit (ASIC), another suitable processing component or device, or one or more combinations thereof. The processor may be coupled with a memory device. The memory device may include random access memory (RAM), read-only memory (ROM) or another memory device, and may store data and/or processor instructions for implementing various functionalities associated with the methods and/or systems described herein. The processor may execute computer instructions stored in the memory or received from another computer device or medium.

A user interface (e.g., graphical user interface) running on one or more processors 116 can allow a user 118 to perform value forecasting 104, portfolio management 106 and place an order to buy or sell security or equity shares for order completion 108. There can be data such as historical time series data 110, portfolio repository and data 112 and order book data 114, used in analysis by the tool, for example, value forecasting and portfolio management. The order book data 114 can be used to train an RL agent of the disclosed RL framework 120 for performing the order completion 108.

FIG. 1B shows an RL framework 120 for RL agent in an embodiment. Starting with an initial trade execution policy 122 and an initial market environment model 124, an agent is trained in three processes: (1) direct RL, where the RL agent uses a state-balanced exploration scheme 132 to interact with the real market 134, collects real experience 128, and improves trade execution policy 122 using real experience 128; (2) environment model learning, where the market environment model 130 is updated 130 using the real experience 128 explored to learn the market dynamics 136; and (3) planning, where the agent improves the trade execution policy 122 using the simulated experience 126 obtained from the learned market environment model 124. In an embodiment, these three processes can take place simultaneously and in parallel in the RL agent.

Direct RL with Deep Double Q-Learning

In an embodiment, a system and/or method approximates the state-action value function (Q-function) via a deep Q-network (DQN) to estimate the expected cumulative return for an agent to perform an action in a given state. In an embodiment, the system and/or method may adopt the double Q-learning method. Such a method may avoid overestimating the Q-values. Specifically, the system and/or method may decouple the target Q-value of the next state into action selection and action evaluation by using the main Q-network Q_{θ} to select the best action, and the target network Q_{π} to estimate the Q-value. Thus, the target Q-value for double Q-learning is

yᵢ=R⁽ⁱ⁾+γQ_{ϕ}(s′⁽ⁱ⁾), arg max_{a′},Q_{θ}(s′⁽ⁱ⁾,a′)), (3)

and the corresponding loss function becomes

$$L ( θ ) = \frac{1}{B} {\sum }_{i = 1}^{B} {( {y}_{i} - {Q}_{θ} ( {s}^{( i )} , {a}^{( i )} ) )}^{2} , \qquad ( 4 )$$

where {s⁽ⁱ⁾, a⁽ⁱ⁾, R⁽ⁱ⁾, s′⁽ⁱ⁾}ᵢ₌₁^{B} is a mini-batch sampled from a replay buffer [symbol] , θ is the parameter of the main network, and ϕ is the parameter of the target network. In an example implementation, the system and/or method may use a “soft” target network update to stabilize the training, by which rather than directly copying the weights after several iterations, the weights of the target network are updated by having them slowly track the learned networks, i.e., ϕ=τθ+(1−τ)ϕ with τ=0.01 in an example setting. In an example implementation, the system and/or method may use a fixed-size first-in-first-out (FIFO) replay buffer to uniformly sample transitions, making samples less correlated. Replay buffer stores data, for example, action, state, and reward, for example, which can be used for training the network or networks.

State-Balanced Exploration for Trade Execution Problem

Sample bias caused by the simple uniform random exploration strategy for trade execution: Classical RL algorithms often use ϵ-greedy scheme to explore new experiences, where the agent starts exploration from an initial state and either takes actions with the current policy or takes a random action till the end of the episode. In the optimal trade execution task, the residual inventory (rest_I) is a part of the agent-state and also confines the action space. Thus, unlike many other domains such as video games, where the action space remains invariant (except some corner cases) over time, the agent has a non-increasing action space in the optimal trade execution task, i.e., the agent can only choose to sell a∈[0, 1, 2, . . . , rest_I] (rest_I is non-increasing) units of shares to make a valid action. Moreover, the agent also has to sell all residual shares by the end of the time period (t=T) to fulfill the trade execution task. Therefore, a simple random exploration scheme would cause a huge bias in the action distribution of generated experiences. Specifically, the system and/or method may use aₜ (t=0 . . . T) to denote the action (the number of units of shares sold) at time t. If the system and/or method applies a random exploration scheme that uniformly chooses an action between 0 and rest_Iₜ (the residual inventory at time t, rest_I₀=I), then there is

[symbol]

[aₜ]=I/2^{t+1} and [symbol] [rest_Iₜ]=I/2^{t}. (5)

A uniform random exploration would on average sell half of the residual inventory at each step and therefore would sell out all shares in the first several steps ignoring the potential benefits of selling more shares later. Therefore, the uniform random exploration steps in ϵ-greedy scheme make it hardly explore the experience that the agent liquidates most inventory in the later time steps.

State-balanced exploration scheme: To solve the sample bias caused by the simple random exploration scheme, the system and/or method in an embodiment may implement the “state-balanced sampling process,” which provides a uniform sampling for all possible valid trade execution plan (a₀, . . . , a_{T}) such that Σₜ₌₀^{T} aₜ=I.

Proposition 1. Given the residual inventory I and residual time steps T, the system and/or method may sample T distinct integers from a uniform distribution over integers 1 to I+T and sort them into an ascending sequence zᵢ (i∈[1 . . . T] and zᵢ<zᵢ₊₁). Let z₀=0 and z_{T+1}=I+T+1, the system and/or method can compute aₜ=zₜ₊₁−zₜ−1 (t∈[0 . . . T]). Then, the sequence (a₀, . . . , a_{T}) is a valid trade execution plan with Σₜ₌₀^{T} aₜ=I and aₜ≥0. Moreover, for any two valid trade execution plans (a₀, . . . , a_{T}) and (a′₀, . . . , a′_{T}), they have an equal chance of being sampled via this sampling process.

Proof. Given the equation Σₜ₌₀^{T} aₜ=I, there is Σₜ₌₀^{T} (aₜ+1)=I+T+1. By “stars and bars”, one valid sequence (a₀, . . . , a_{T}) corresponds to a partition plan of I+T+1 stars (which has I+T gaps in between) using T bars. The configurations of bars are one-to-one and onto mapped with the valid sequences. Therefore, the system and/or method can uniformly sample the valid sequences by uniformly sample the locations of bars. Thus, a sampling process herein in an embodiment provides a uniform sampling for all valid trade execution plan.

Subsequently, the system and/or method can replace the simple uniform random action sampling steps in the classical ϵ-greedy by the state-balanced sampling process depicted in Proposition 1 to form the state-balanced exploration scheme. In an embodiment, the state-balanced sampling process can be used to sample all random actions at the beginning of exploration, and it can also be used to sample a one-step random action given the residual inventory and the residual time steps (by taking the first action only). For example, the RL agent can start exploration from states, whose residual time and residual inventory are sampled uniformly, and thus, the agent could explore all possible combinations of the residual time and the residual inventory uniformly and find a better trading strategy. Experiments show that the state-balanced exploration scheme better explores the action space and also improves the performance of the learned policy compared with the policy learned using the ϵ-greedy scheme.

Planning with the Learnable Environment Model

The system and/or method in an embodiment may develop a learnable market environment model 124 to generate the simulated experience 126 that can be used to improve the trade execution policy 122. For instance, storage or buffer at 126 stores simulated data such as simulated action, state and reward, e.g., simulated by the learnable market environment model 124. In a specific example, the system and/or method uses a neural network M_{ψ}(s, a) parameterized by ψ to predict the state s′ at the next time step after executing action a. Since the transition of the agent state (residual inventory, residue time, and decision price p_{D}) is fixed given the chosen action, predicting the next state can include a regression task of simulating the next market state s′ₘ (i.e., market statistics and the volumes of different levels of LOB). In an embodiment, the system and/or method need not predict the reward since it can be computed using the current market state and the chosen action. In an embodiment, the environment model M_{ψ}(s, a) 124 is updated 130 via the mini-batch stochastic gradient descent (SGD) using real experience 128 sampled from the replay buffer [symbol] and is optimized with L2-loss. For instance, storage or buffer at 128 stores real data such as real action, state and reward, collected from interacting with real market. In an embodiment, learning and planning can be accomplished with the learnable market environment model 124, operating on real experience in storage 128 for learning and on simulated experience in 126 for planning.

In an embodiment, to avoid the potential error accumulation of the learned environment, instead of generating a sequence of simulated experience starting from the initial state, the system and/or method may only generate one-step simulated experience starting from a real state s sampled from the replay buffer [symbol] . Specifically, the system and/or method may also use the state-balanced exploration scheme to sample a one-step action a for the starting real state s. Then the system and/or method may compute the corresponding reward r based on the market state in s and use the environment model M_{ψ}(s, a) 124 to generate the next state s′. In an embodiment, the system and/or method may interleave the updates of the policy 122 using the real experience 128 and the updates using the simulated experience 126 obtained from the learned market environment model 124. Experiments show that by performing multiple updates using the simulated experience 126 per update using the real experience 128, the system and/or method can speed up the policy learning without degrading the final performance of the learned policy 122, which reduces the training overhead when it is applied to the real market.

A trained RL agent can be stored in a model repository 140, e.g., shown in FIG. 1C. Incoming order book streaming data 142, e.g., received via an application programming interface, can be stored. The RL framework can use the incoming order book streaming data 142 for continually training the RL agent. The order completion at 108 (FIG. 1A) can trigger the trained RL agent to run to perform order completion. FIG. 1D shows order completion user interface (UI), via which orders can be input.

As an example experiment implementation for evaluating the disclosed framework, a number of stocks, for example, from different market sectors, can be selected. Their limited order book data ranging in time (e.g., 10-month data) can be obtained. In an embodiment, the example experiment implementation can use a queue-reactive-based virtual market to represent the real dynamic market environment. For example, one may set the time step to be one second and use the average order size of level-1 (AOS₁) as the trade execution unit. Given this setting, the intensity of new MOs, new LOS, and cancellation of LOs can be calculated that determines the queue length increasing rate (decreasing rate) and the shift of price at each level k. Considering the liquidity of the selected stocks, the initial inventory can be set to be 80 trade execution units (I=80) and the number of time steps to sell all shares to be 16 (T=16). The average trading cost (ATC) can be used as the performance metrics, which measures the average relative trading cost compared with selling all stocks at the decision-price p_{D}, i.e.,

ATC=(The average selling price−p_{D})/p_{D}.

ATC is a regret value with respect to the decision price at the beginning of the trading horizon. The basis point (0.01%) can be used as the unit of ATC and ATC can be a negative number due to market impact (the price drops down when one is liquidating one's stocks). To cancel the variation caused by the market, the performance of all models can be calculated using 1,000 trading tests with different random seeds to report the mean and the standard deviation. For benchmark models, one can follow their original configuration and exhaustively explore the hyper-parameters to saturate their performance.

Existing works for optimal trade execution use historical data as their training set and assume that their own execution is negligible to the whole market. Training an automated machine learning agent to consider market impact of its actions, for instance, via the disclosed planning module, for example, as disclosed herein in an embodiment, can improve the performance of the automated agent.

Experiments demonstrate the advantage of the disclosed state-balanced exploration scheme. Benchmarking the performance of the disclosed RL framework and comparing it with other optimal trade execution baselines shows that the disclosed RL framework provides efficiency. An example experimentation saturated all models' performance by training all of them with massive real experience (200,000 real exploration episodes) in a dynamic virtual market. For the disclosed RL framework approach, one can evaluate two settings, i.e., the basic setting without planning and the setting with 7 planning updates per real experience update. The results show that the disclosed RL framework achieves a better average ATC trading cost than all the model-free RL baselines as well as classical trade execution strategies across the stocks used in the experiment. The experiment results also suggest that the disclosed RL framework can capture more complicated market dynamics. With the same amount of real experience, the disclosed RL framework's performance is further boosted using the simulated experience (the disclosed RL framework with 7 planning updates), which explores more possible execution plans.

Comparing the performance between the disclosed RL framework and another method in the experiment, it can be shown that the disclosed state-balanced exploration scheme can be advantageous over the simple ϵ-greedy exploration strategy. As an illustrative example, the policies learned by the disclosed RL framework and another method on a selected stock is visualized. It is shown that due to the exploration bias of the simple random exploration strategy, the agent trained by the known method tends to sell about half of the inventory (I=80) at the first several steps leaving few actions for the following steps. In contrast, the agent trained with the disclosed RL framework has a more “patient” trading strategy that can even liquidate a significant portion of shares in the last several steps, which leads to better overall performance compared with the known method.

Reducing Exploration Cost Via Planning

In an aspect, the planning module disclosed herein can reduce the training cost. To demonstrate such reduction in the training cost, one can compare the convergence behavior of the disclosed framework trained with different planning update frequency. One may keep the same setting for the total time steps and the total trading volume (I=80, T=16), and vary the number of planning updates per real experience update. One may use the name RL framework(n) to denote the framework model trained with n planning updates per real experience update (RL framework(0) denotes the model trained without planning update). The test performance trajectories of two selected stocks can be observed. In the test, it is observed that, RL framework (7) reaches−13 (−17) ATC within 30,000 (20,000) real market interactions while it takes about 100,000 (70,000) real market interactions for RL framework (0) to achieve the same ATC value. Therefore, the planning module can increase the convergence rate leading to a lower training cost when it is applied to real markets. From the observations, one can see that the disclosed RL framework for optimal trade execution reduces the market impact cost and increases sample efficiency in training.

In an embodiment, the hybrid RL framework disclosed herein integrates deep reinforcement learning and planning for optimal trade execution under dynamic market environments. Experiments demonstrate that the hybrid RL framework increases sample efficiency, reduces the market impact cost, and outperforms existing methods.

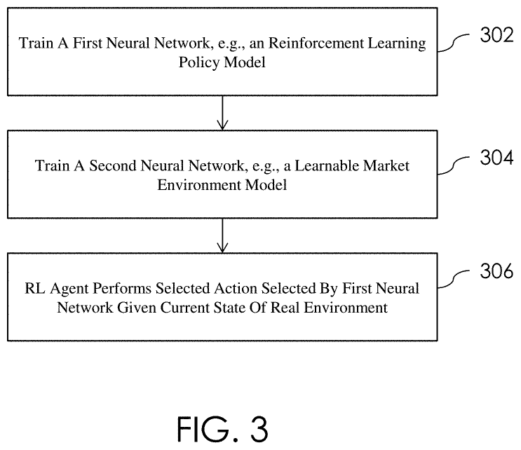

FIG. 3 is a flow diagram illustrating a method in an embodiment for cost-efficient deep Q-learning in an embodiment. The method shows training machine learning models in a reinforcement learning framework, which models can be used for order completion in an embodiment. At 302, a first neural network is trained to approximate a state-action value function to estimate an expected cumulative return for an agent to perform an action in a given state. The first neural network, for example, can be the RL policy model described herein with reference to FIG. 1B at 122. The first neural network can include a deep Q-learning network, e.g., a deep double Q-learning network, and the state-action value function can include a Q-function. The agent can be an autonomous reinforcement learning agent running on the processor, for example, a controller on the processor.

At 304, a second neural network is trained to generate a simulated experience, the second network trained to predict a simulated state at a next time step after performing a given action, the second neural network being trained using real experience in a real environment. The first neural network can be trained using the simulated experience and a real experience from a real environment. The second neural network, for example, can be the learnable market environment model described herein with reference to FIG. 1B at 124.

At 306, the method can include the agent performing a selected action selected by the first neural network given a current state of the real environment. In an embodiment, the agent can also uniformly explore an action space by uniformly sampling an action from all possible remaining action-state space combinations, for example, as described herein with reference to the state-balanced exploration scheme, and performing the sampled action.

The method can also include retraining the first neural network using as additional training data, the sampled action, a state of the real environment after the sampled action is taken, and a reward associated with the sampled action received from the real environment.

The method can also include performing multiple updates to the first neural network using the simulated experience generated by the second neural network per an update to the first neural network using the real experience received from the real environment.

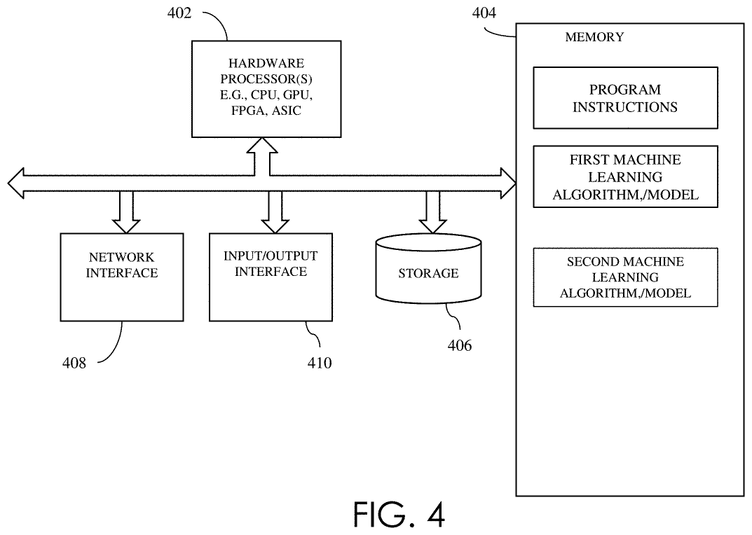

FIG. 4 is a diagram showing components of a system in one embodiment that can provide a reinforcement learning (RL) framework for order completion on dynamic market. One or more hardware processors 402 such as a central processing unit (CPU), a graphic process unit (GPU), and/or a Field Programmable Gate Array (FPGA), an application specific integrated circuit (ASIC), and/or another processor, may be coupled with a memory device 404, and train a first neural network, for example, an RL policy model, which can approximate a state-action value function to estimate an expected cumulative return for an agent to perform an action in a given state. The agent can be an autonomous reinforcement learning agent running on the processor. One or more processors 402 can also train a second neural network to generate a simulated experience, the second network trained to predict a simulated state at a next time step after performing a given action, the second neural network being trained using real experience in a real environment. One or more processors 402 can train the first neural network based on the simulated experience and a real experience from a real environment. A memory device 404 may include random access memory (RAM), read-only memory (ROM) or another memory device, and may store data and/or processor instructions for implementing various functionalities associated with the methods and/or systems described herein. One or more processors 402 may execute computer instructions stored in memory 404 or received from another computer device or medium. A memory device 404 may, for example, store instructions and/or data for functioning of one or more hardware processors 402, and may include an operating system and other program of instructions and/or data. One or more hardware processors 402 may receive input including dynamic market data, action, state and reward data, which may be stored in a storage device 406 or received via a network interface 408 from a remote device, and may be temporarily loaded into a memory device 404 for building or generating the first neural network and the second neural network. The learned neural network models may be stored on a memory device 404, for example, for running by one or more hardware processors 402. One or more hardware processors 402 may be coupled with interface devices such as a network interface 408 for communicating with remote systems, for example, via a network, and an input/output interface 410 for communicating with input and/or output devices such as a keyboard, mouse, display, and/or others.

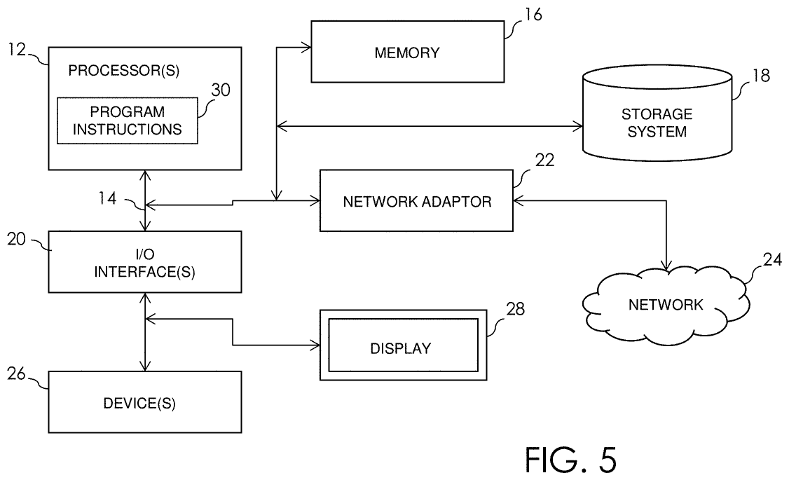

FIG. 5 illustrates a schematic of an example computer or processing system that may implement a system in one embodiment. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 5 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being run by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

It is understood in advance that although this disclosure may include a description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

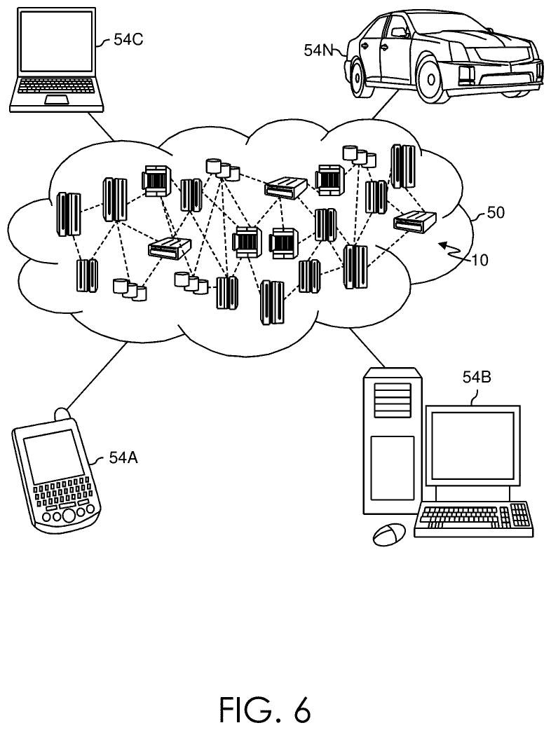

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

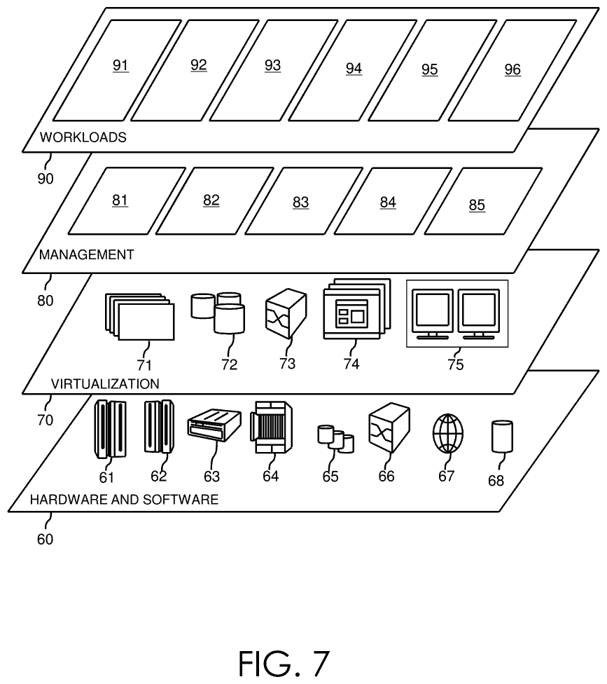

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and RL framework processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, run concurrently, substantially concurrently, in a partially or wholly temporally overlapping manner, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in an embodiment” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A reinforcement machine learning system comprising:
a processor; and
a memory device coupled with the processor;
the processor configured to at least:
train a first neural network to approximate a state-action value function to estimate an expected cumulative return for an agent to perform an action in a given state, the agent being an autonomous reinforcement learning agent running on the processor;
train a second neural network to generate a simulated experience, the second network trained to predict a simulated state at a next time step after performing a given action, the second neural network being trained using real experience in a real environment; and
the first neural network being trained based on the simulated experience and a real experience from a real environment,
wherein the agent is configured to perform a selected action selected by the first neural network given a current state of the real environment.

2. The system of claim 1, wherein the agent is configured to uniformly explore an action space by uniformly sampling an action from all possible remaining action-state space combinations and performing the sampled action.

3. The system of claim 2, wherein the processor is further configured to retrain the first neural network using as additional training data, the sampled action, a state of the real environment after the sampled action is taken, and a reward associated with the sampled action received from the real environment.

4. The system of claim 1, wherein the processor is configured to interleave using of the simulated experience generated by the second neural network and the real experience from the real environment.

5. The system of claim 4, wherein the interleaving includes performing multiple updates using the simulated experience generated by the second neural network per an update using the real experience received from the real environment.

6. The system of claim 1, wherein the first neural network includes a deep Q-learning network and the state-action value function includes a Q-function.

7. The system of claim 1, wherein the first neural network includes a deep double Q-learning network.

8. The system of claim 1, wherein the action includes buying and selling a security share in order completion.

9. A computer-implemented method comprising:
training a first neural network to approximate a state-action value function to estimate an expected cumulative return for an agent to perform an action in a given state, the agent being an autonomous reinforcement learning agent running on the processor;
training a second neural network to generate a simulated experience, the second network trained to predict a simulated state at a next time step after performing a given action, the second neural network being trained using real experience in a real environment, wherein the first neural network is trained based on the simulated experience and a real experience from a real environment; and
performing a selected action selected by the first neural network given a current state of the real environment.

10. The method of claim 9, further including uniformly exploring an action space by uniformly sampling an action from all possible remaining action-state space combinations and performing the sampled action.

11. The method of claim 10, further including retraining the first neural network using as additional training data, the sampled action, a state of the real environment after the sampled action is taken, and a reward associated with the sampled action received from the real environment.

12. The method of claim 9, further including performing multiple updates to the first neural network using the simulated experience generated by the second neural network per an update to the first neural network using the real experience received from the real environment.

13. The method of claim 9, wherein the first neural network includes a deep Q-learning network and the state-action value function includes a Q-function.

14. The method of claim 9, wherein the first neural network includes a deep double Q-learning network.

15. The method of claim 9, wherein the action includes buying and selling a security share in order completion.

16. A computer program product comprising a computer readable storage medium having program instructions embodied therewith, the program instructions readable by a device to cause the device to:
train a first neural network to approximate a state-action value function to estimate an expected cumulative return for an agent to perform an action in a given state, the agent being an autonomous reinforcement learning agent running on the processor;
train a second neural network to generate a simulated experience, the second network trained to predict a simulated state at a next time step after performing a given action, the second neural network being trained using real experience in a real environment, wherein the first neural network is trained based on the simulated experience and a real experience from a real environment; and
perform a selected action selected by the first neural network given a current state of the real environment.

17. The computer program product of claim 16, further including uniformly exploring an action space by uniformly sampling an action from all possible remaining action-state space combinations and performing the sampled action.

18. The computer program product of claim 17, further including retraining the first neural network using as additional training data, the sampled action, a state of the real environment after the sampled action is taken, and a reward associated with the sampled action received from the real environment.

19. The computer program product of claim 16, further including performing multiple updates to the first neural network using the simulated experience generated by the second neural network per an update to the first neural network using the real experience received from the real environment.

20. The computer program product of claim 16, wherein the first neural network includes a deep Q-learning network and the state-action value function includes a Q-function.
